(19) United States
(12) Patent Application Publication
(10) Pub. No.: US 2017/0024051 A1
(43) Pub. Date: Jan. 26, 2017

(54) MULTITOUCH FRAME MATCHING WITH DISTANCE FIELDS

(71) Applicant: Tactual Labs Co., New York, NY (US)

(72) Inventors: Bruno Rodrigues De Araujo, Toronto (CA); Ricardo Jorge Jota Costa, Toronto (CA); Clifton Forlines, Toronto (CA)

(73) Assignee: Tactual Labs Co., New York, NY (US)

(21) Appl. No.: 15/056,813

(22) Filed: Feb. 29, 2016

Related U.S. Application Data
(60) Provisional application No. 62/121,970, filed on Feb. 27, 2015.

(51) Int. Cl. G06F 3/041

(52) U.S. Cl. CPC G06F 3/0416; G06F 2203/04104

(57) ABSTRACT

Disclosed are a touch sensitive device and corresponding method that utilizes distance fields for frame matching. The device includes a touch interface having row conductors and column conductors. A row signal generator transmits a row signal on at least one of the row conductors. A touch processor is used to process column signals from data received on at least one of the column conductors. The touch processor is configured to use discrete values from the column signals to compute a distance field function and store a representation of a distance field grid for a current frame, use the representation of the distance field grid to determine data representing a state change, and use the data representing a state change to match at least one touch location from a previous frame to at least one touch location in the current frame.

This application is a non-provisional of and claims priority to U.S. Provisional Patent Application No. 62/121,970 filed Feb. 27, 2015, the entire disclosure of which is incorporated herein by reference.

### FIELD

The disclosed system and method relate in general to the field of user input, and in particular to user input systems which provide multitouch frame matching.

### BACKGROUND

The present invention relates to touch sensors, examples of which are disclosed in U.S. patent application Ser. No. 14/945,083 filed Nov. 18, 2015, the entire disclosure of which is incorporated herein by reference.

Touch sensors, such as capacitive based touch sensing technology, often rely on bi-dimensional grids to detect finger locations on a flat interactive surface. Such a grid can be seen as mapping sensor values at each crossing between rows and columns depending on the presence of one or more touches on top of the sensor. Given both the size of grid cells and that of a finger, touch locations can be extracted by evaluating value variations at each crossing of such grid. This touch location identification process usually relies on methods that search for local minima or maxima on the grid. This process is repeated at each frame (i.e. when sensor readings are refreshed). To devise software applications which take advantage of the inherent continuity of human touch based interaction, touches need to be correlated between consecutive frames. Such process can be designated as “Frame Matching” and usually involves providing a unique touch identifier for touches related to the same finger while they are in contact with the surface. Given a set of 2D touch locations between two consecutive frames, this usually requires computing pairs of closest distance points among other steps.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 shows a diagram illustrating a representation of a distance field using dashed level curves around two finger touches.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to operational illustrations of methods and devices for utilizing distance fields in processing touch data. It is understood that each step disclosed may be implemented by means of analog or digital hardware and computer program instructions. These computer program instructions may be stored on computer-readable media and provided to a processor of a general purpose computer, special purpose computer, ASIC, Field-Programmable Gate Array (FPGA), or other programmable data processing apparatus, such that the instructions, which execute via the processor of the computer or other programmable data processing apparatus, implements the functions/acts described. In some alternate implementations, the functions/acts described may occur out of the order noted in the operational illustrations. For example, two functions shown in succession may in fact be executed substantially concurrently or the functions may sometimes be executed in the reverse order, depending upon the functionality/acts involved.

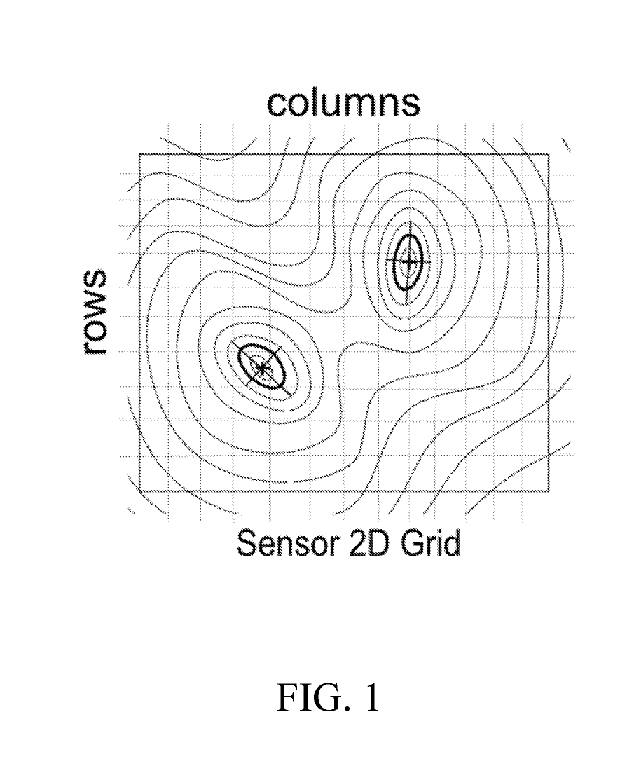

With reference to FIG. 1, the distance field is created using the values provided by the sensor at each row/column crossing of the grid. Precise position, area and orientation of a finger or other object (such as a stylus or hand) can be extracted from the distance field for each touch per frame and matched with the previous frame map for finger unique identification.

In accordance with an embodiment of the invention, a continuous representation of the bi-dimensional grid is used to speed up and more accurately analyze touch changes on touch sensors. Such method enables the sensor to obtain a more precise snapshot of the cell neighborhood (i.e. its state) by evaluating such continuous representation in any location of the grid (or even within a cell). The discrete values, gathered along each sensor row and column, are used to compute the distance field function in a manner similar to a continuous 2.5D heightfield.

The distance field function can be described as a weighted sum of distance functions or kernels (polynomial or Gaussian) using the known location of existing 2D touches or providing a continuous approximation or interpolation of existing grid crossing values. The continuous representation can be computed using, for example, a thin-plate interpolation method or least square error based fitting. The advantage of such continuous representation, versus the original discrete grid values, is to allow the sensor to perform differential analysis directly on the distance field and better understand the state changes happening on top of the touch sensor. Differential values can be generated for each cell of the grid using a marching algorithm to speedup the process and generate continuous alternatives to the distance field (velocity, gradient, curvature information). In an embodiment, the disclosed device and method allows taking advantage of the gradient information of the distance field to converge to the closest touch point between frames. Iterative process such as Newton-Raphson method can be used to search for local minima and maxima supporting and speeding-up the touch location process, as well as the matching between frames. Frame matching could be done by performing a lookup to the distance field and converging to the closest and most probable previous identified touch using the gradient information of the distance field. The continuous representation also enables the sensor to better handle existing noise on the sensor and use multi-scale analysis methods for a more robust detection of touch location and to correctly classify subtle noise changes from relevant touch information. Finally, it can also be used for inter-frame sample generation or support touch location predictive algorithms. The processing algorithms described in this section are parallelizable (similar to image processing) and can be implemented directly in hardware using accelerated Graphic Processor Units or FPGA based controllers.

Beyond detection of touch points, a multi-frame distance field representation supports the detection of larger-than-finger touches, such as those created by a palm or other object on the touch sensitive area. Such detection is advantageous as many systems work to ignore touch input performed by things other than the user's fingers.

Additionally, a multi-frame distance field has applications in detecting the pressing and lifting of fingers and other touches onto and off of the touch sensitive area. Because the human body is deformable, it changes shape as the pressure between the body and touch sensitive surface changes. As such, the contact area and capacitive connection between the body and touch surface change over time. A distance field representation of the touch sensor will aid in the detection of these changes and aid in the detection of current and prediction of future lift-off and touch-down actions. It will also allow detection of micro finger gestures such as rolling the finger on top of the surface. By directly analyzing the derivative of the distance field, the gradient vector, could define a signed function describing micro-changes happening by moving the finger. Rolling the finger to the left or the right can be classified using this information and complement the area descriptor of a finger defined by its principal axis. It robustly allows the sensor to detect when a finger is rotating on the surface extending the existing 2D multi-touch lexicon. This information combined with second derivative analysis also allows the sensor to explore curvature information and better correlate the different values provided by the sensor and make a reliable pressure measure available to applications. Combining the positional touch data, with direction, curvature and pressure allows the sensor to feed both gesture recognition algorithms and stroke fitting to present high-level representation of the touch interaction to any touch based applications.

The present invention can be applied to conventional touch sensors and also to fast multi-touch sensors, in which unique frequencies are injected on each row in a row/column matrix and each column senses these frequencies whenever a touch bridges the gap between row and column. The latter type of sensors are disclosed, e.g., in U.S. patent application Ser. No. 14/614,295 filed Feb. 4, 2015, the entire disclosure of which is incorporated herein by reference.

In an embodiment, the touch processing described herein could be performed on a touch sensor's discrete touch controller. In another embodiment, such analysis and touch processing could be performed on other computer system components such as but not limited to ASIC, MCU, FPGA, CPU, GPU, SoC, DSP or a dedicated circuit. The term “hardware processor” as used herein means any of the above devices or any other device which performs computational functions.

Throughout this disclosure, the terms “touch”, “touches,” or other descriptors may be used to describe events or periods of time in which a user's finger, a stylus, an object or a body part is detected by the sensor. In some embodiments, these detections occur only when the user is in physical contact with a sensor, or a device in which it is embodied. In other embodiments, the sensor may be tuned to allow the detection of “touches” that are hovering a distance above the touch surface or otherwise separated from the touch sensitive device. Therefore, the use of language within this description that implies reliance upon sensed physical contact should not be taken to mean that the techniques described apply only to those embodiments; indeed, nearly all, if not all, of what is described herein would apply equally to “touch” and “hover” sensors. As used herein, the phrase “touch event” and the word “touch” when used as a noun include a near touch and a near touch event, or any other gesture that can be identified using a sensor.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in their entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A touch sensitive device that utilizes distance fields for frame matching, comprising:
i) touch interface comprising row conductors and column conductors;
ii) row signal generator for transmitting a first row signal on at least one of the row conductors;
iii) touch processor configured to process column signals from data received on at least one of the column conductors, the touch processor being configured to:
(1) use discrete values from the column signals to compute a distance field function and store a representation of a distance field grid for a current frame;
(2) use the representation of the distance field grid to determine data representing a state change; and,
(3) use the data representing a state change to match at least one touch location from a previous frame to at least one touch location in the current frame.

2. The touch sensitive device according to claim 1, wherein the step of using the data representing a state change to match at least one touch location comprises using the distance field grid to determine touch position.

3. The touch sensitive device according to claim 1, wherein the step of using the data representing a state change to match at least one touch location comprises using the distance field grid to determine area of a touch point.

4. The touch sensitive device according to claim 1, wherein the step of using the data representing a state change to match at least one touch location comprises using the distance field grid to determine orientation of a touch point.

5. The touch sensitive device according to claim 1, wherein the distance field function is computed as a weighted sum of distance functions using a known location of a touch position in one or more previous frames.

6. The touch sensitive device according to claim 1, wherein the distance field function is computed as a weighted sum of distance kernels using a known location of a touch position in one or more previous frames.

7. The touch sensitive device according to claim 1, wherein the distance field function is computed using thin-plate interpolation.

8. The touch sensitive device according to claim 1, wherein the distance field function is computed using least squares error based fitting.

9. The touch sensitive device according to claim 1, wherein differential values are generated for each cell of the distance field grid using a marching algorithm.

10. The touch sensitive device according to claim 9, wherein the marching algorithm is used to generate continuous alternatives to the distance field.

11. The touch sensitive device according to claim 10, wherein the continuous alternatives comprise velocity information.

12. The touch sensitive device according to claim 10, wherein the continuous alternatives comprise gradient information.

13. The touch sensitive device according to claim 12, wherein the processor is further configured to use the gradient information to converge to a closest touch point between frames.

14. The touch sensitive device according to claim 10, wherein the continuous alternatives comprise curvature information.

15. The touch sensitive device according to claim 1, wherein the step of using the data representing a state change to match at least one touch location comprises converging to a closest and most probable previous identified touch using gradient information of the distance field.

16. The touch sensitive device according to claim 1, wherein the touch processor comprises a graphics processing unit.

17. The touch sensitive device according to claim 1, wherein the touch processor comprises an FPGA based controller.

18. The touch sensitive device according to claim 1, further comprising:
a second row signal generator for transmitting a second row signal that is orthogonal to the first row signal.

19. The touch sensitive device according to claim 1, wherein the touch processor is further configured to process row signals from data received on at least one of the row conductors.

20. A touch sensitive device that utilizes distance fields to identify local minima and maxima in a frame, comprising:
i) touch interface comprising row conductors and column conductors;
ii) row signal generator for transmitting a first row signal on at least one of the row conductors;
iii) touch processor configured to process column signals from data received on at least one of the column conductors, the touch processor being configured to:
(1) use discrete values from the column signals to compute a distance field function and store a representation of a distance field grid for a current frame;
(2) use the representation of the distance field grid to identify local minima and maxima in the current frame.

21. The touch sensitive device according to claim 20, wherein the step of using the distance field grid to identify local minima and maxima comprises using an iterative process.

22. The touch sensitive device according to claim 21, wherein the iterative process comprises a Newton-Raphson method.

23. The touch sensitive device according to claim 20, wherein the step of using the representation of the distance field grid comprises using the distance field grid to determine touch position.

24. The touch sensitive device according to claim 20, wherein the step of using the distance field grid comprises matching at least one touch location using the distance field grid to determine area of a touch point.

25. The touch sensitive device according to claim 20, wherein the step of using the distance field grid comprises matching at least one touch location using the distance field grid to determine orientation of a touch point.

26. The touch sensitive device according to claim 20, wherein the distance field function is computed as a weighted sum of distance functions using a known location of a touch position in one or more previous frames.

27. The touch sensitive device according to claim 20, wherein the distance field function is computed as a weighted sum of distance kernels using a known location of a touch position in one or more previous frames.

28. The touch sensitive device according to claim 20, wherein the distance field function is computed using thin-plate interpolation.

29. The touch sensitive device according to claim 20, wherein the distance field function is computed using least squares error based fitting.

30. The touch sensitive device according to claim 20, wherein differential values are generated for each cell of the distance field grid using a marching algorithm.

31. The touch sensitive device according to claim 30, wherein the marching algorithm is used to generate continuous alternatives to the distance field.

32. The touch sensitive device according to claim 31, wherein the continuous alternatives comprise velocity information.

33. The touch sensitive device according to claim 31, wherein the continuous alternatives comprise gradient information.

34. The touch sensitive device according to claim 33, wherein the processor is further configured to use the gradient information to converge to a closest touch point between frames.

35. The touch sensitive device according to claim 31, wherein the continuous alternatives comprise curvature information.

36. The touch sensitive device according to claim 20, wherein the step of using the data representing a state change to match at least one touch location comprises converging to a closest and most probable previous identified touch using gradient information of the distance field.

37. The touch sensitive device according to claim 20, wherein the touch processor comprises a graphics processing unit.

38. The touch sensitive device according to claim 20, wherein the touch processor comprises an FPGA based controller.

39. The touch sensitive device according to claim 20, further comprising:
a second row signal generator for transmitting a second row signal that is orthogonal to the first row signal.

40. The touch sensitive device according to claim 20, wherein the touch processor is further configured to process row signals from data received on at least one of the row conductors.

41. A method of sensing touch utilizing distance fields for frame matching on a device having a touch interface comprising row conductors and column conductors, the method comprising:
transmitting a first unique orthogonal row signal on a first row conductor;
transmitting a second unique orthogonal row signal on a second row conductor, each of the first and second row signals being unique and orthogonal with respect to each other;
detecting column signals present on at least one of the column conductors;
using discrete values from the column signals to compute a distance field function and store a representation of a distance field grid for a current frame;
using the representation of the distance field grid to determine data representing a state change;
using the data representing a state change to match at least one touch location from a previous frame to at least one touch location in the current frame; and,
identifying a touch event on the touch interface using the state change.

42. The method according to claim 41, wherein the step of using the data representing a state change to match at least one touch location comprises using the distance field grid to determine touch position.

43. The method according to claim 41, wherein the step of using the data representing a state change to match at least one touch location comprises using the distance field grid to determine area of a touch point.

44. The method according to claim 41, wherein the step of using the data representing a state change to match at least one touch location comprises using the distance field grid to determine orientation of a touch point.

45. The method according to claim 41, wherein the distance field function is computed as a weighted sum of distance functions using a known location of a touch position in one or more previous frames.

46. The method according to claim 41, wherein the distance field function is computed as a weighted sum of distance kernels using a known location of a touch position in one or more previous frames.

47. The method according to claim 41, wherein the distance field function is computed using thin-plate interpolation.

48. The method according to claim 41, wherein the distance field function is computed using least squares error based fitting.

49. The method according to claim 41, wherein differential values are generated for each cell of the distance field grid using a marching algorithm.

50. The method according to claim 49, wherein the marching algorithm is used to generate continuous alternatives to the distance field.

51. The method according to claim 50, wherein the continuous alternatives comprise velocity information.

52. The method according to claim 50, wherein the continuous alternatives comprise gradient information.

53. The method according to claim 52, further comprising using the gradient information to converge to a closest touch point between frames.

54. The method according to claim 50, wherein the continuous alternatives comprise curvature information.

55. The method according to claim 41, wherein the step of using the data representing a state change to match at least one touch location comprises converging to a closest and most probable previous identified touch using gradient information of the distance field.

56. The method according to claim 41, wherein the step of identifying a touch event is performed by a graphics processing unit.

57. The method according to claim 41, wherein the step of identifying a touch event is performed by an FPGA based controller.
